(19) United States
(12) Patent Application Publication
(10) Pub. No.: US 2024/0169199 A1
(43) Pub. Date: May 23, 2024

(54) METHOD, DEVICE AND COMPUTER-READABLE MEDIUM FOR TRAINING MACHINE LEARNING MODEL PERFORMING COMPETENCY EVALUATION ON PLURALITY OF COMPETENCIES

(71) Applicant: GENESIS LAB INC., Seoul (KR)

(72) Inventors: Jaeyoung KIM, Hwaseong-si, Gyeonggi-do (KR); Daehun YOO, Seoul (KR); Junhong KIM, Seoul (KR); Sehun KIM, Gyeonggi-do (KR); Seokkyu CHOI, Seoul (KR); Bokyung KO, Seoul (KR); Jonghwa LEE, Seoul (KR); Jeongvin KANG, Seoul (KR)

(21) Appl. No.: 18/258,899

(22) PCT Filed: Nov. 25, 2021
(86) PCT No.: PCT/KR2021/017514

§ 371 Date: Jun. 22, 2023

(30) Foreign Application Priority Data
Jan. 25, 2021 (KR) 10-2021-0010237

(51) Int. Cl. G06N 3/08

(52) U.S. Cl. CPC G06N 3/08

(57) ABSTRACT

The present invention relates to a method, a device and a computer-readable medium for training a machine learning model performing competency evaluation on a plurality of competencies, and more particularly, to a method, a device and a computer-readable medium for training a machine learning model performing competency evaluation on a plurality of competencies to efficiently train the machine learning model for outputting an evaluation result of each of the competencies from input data related to answers and the like of an evaluatee.

### TECHNICAL FIELD

The present invention relates to a method, a device and a computer-readable medium for training a machine learning model performing competency evaluation on a plurality of competencies, and more particularly, to a method, a device and a computer-readable medium for training a machine learning model performing competency evaluation on a plurality of competencies to efficiently train the machine learning model for outputting an evaluation result of each of the competencies from input data related to answers and the like of an evaluatee.

### BACKGROUND ART

Recently, the number of jobs that require complex tasks is increasing in companies due to the fourth industrial technology. Due to rising labor costs and difficulties in the business environments, companies are seeking various recruitment processes of selecting the most suitable talented persons for the job they want to hire.

As part of this recruitment process, public institutions, such as public corporations, are implementing a recruitment process that verifies applicants' abilities and competencies based on the National Competency Standards (NCS), and private companies are applying assessment schemes, such as assessment center, work sample test, ability test, modern personality test, biographies (bio-data), references check, and traditional interviews, for determining whether an applicant has various competencies suitable for the corresponding job to the recruitment process.

Since the conventional schemes for evaluating competency as described above are required to be performed by an evaluator having received specialized training or having rich experiences in the evaluation schemes, it burdens a lot of money on the company conducting the evaluation to train related experts or hire experts, and the evaluator is required to perform detailed procedures for the evaluation even when the evaluation is conducted by an expert, a significant amount of time is required to perform the evaluation.

Therefore, it is necessary to significantly reduce the time and cost used for evaluation and develop an evaluation method for improving the objectivity of evaluation results, by implementing a method for evaluating the competency possessed by the evaluatee online through a machine learning model.

### DISCLOSURE

### Technical Problem

An object of the present invention is to provide a method, a device and a computer-readable medium for training a machine learning model performing competency evaluation on a plurality of competencies to efficiently train the machine learning model for outputting an evaluation result of each of the competencies from input data related to answers and the like of an evaluatee.

### Technical Solution

In order to solve the above problem, one embodiment of the present invention provides a method for training a machine learning model performing competency evaluation on a plurality of competencies and performed on a computing device having at least one processor and at least one memory, in which the machine learning model includes: a backbone artificial neural network module for deriving intermediate feature information from input data; and a sub-artificial neural network module for evaluating each competency from the intermediate feature information, and the method includes a labeling learning step of training the backbone artificial neural network module and the sub-artificial neural network module for a specific competency so as to reduce an error between a first prediction information obtained by inputting intermediate feature information, which is output by inputting learning input data for the specific competency to the backbone artificial neural network module, to the sub-artificial neural network module for the specific competency and labeling information for the learning input data.

In some embodiments of the invention, the output information of the sub-artificial neural network module may include score information for the corresponding competency, and behavior index information for a behavior index in which the corresponding competency is found.

In some embodiments of the invention, the input data may include text, and the output information of the sub-artificial neural network module may include the corresponding competency or a position in which the behavior index related to the corresponding competency is found in the text.

In some embodiments of the invention, the input data may include video information or voice information with or without preprocessing, and the output information of the sub-artificial neural network module may include time information or position in video information or voice information in which the corresponding competency or behavior index related to the corresponding competency is found.

In some embodiments of the invention, the method for training a machine learning model performing competency evaluation on a plurality of competencies includes: a prediction labeling information generation step of generating prediction labeling information based on second prediction information obtained by inputting intermediate feature information, which is output by inputting learning input data for the specific competency to the backbone artificial neural network module, to the sub-artificial neural network module for other competency different from the specific competency; and a prediction labeling learning step of training the backbone artificial neural network module and a sub-artificial neural network module for other competency different from the specific competency so as to reduce an error between a third prediction information obtained by inputting intermediate feature information, which is output by inputting learning input data for the specific competency to the backbone artificial neural network module, to the sub-artificial neural network module for the other competency different from the specific competency and prediction labeling information for the learning input data.

In some embodiments of the invention, the prediction labeling information generating step may include generating the prediction labeling information by considering uncertainty of a prediction result calculated from the second prediction information.

In some embodiments of the invention, the second prediction information may include probability information for a plurality of result classes, and the prediction labeling information generating step may include performing a competency evaluation for generating the prediction labeling information by considering uncertainty in probability information of each of the result classes.

In some embodiments of the invention, the second prediction information may include a regression result value and deviation information, and the prediction labeling information generating step may include generating the prediction labeling information by considering uncertainty derived from the deviation information.

In some embodiments of the invention, in the prediction labeling information generating step, when the uncertainty of the prediction result calculated from the second prediction information is a preset reference or more, the prediction labeling learning step may not be performed without generating the prediction labeling information.

In some embodiments of the invention, the input data may include at least one of text, voice information, and video information with or without preprocessing, and the backbone artificial neural network module may correspond to a multi-modal artificial neural network module.

In some embodiments of the invention, the input data may include tokenized text information and category information of a question related to the text information, and the machine learning model for performing the competency evaluation may include a model for evaluating competency based on at least one of past behaviors and attitudes.

In order to solve the above problem, one embodiment of the present invention provides a device for training a machine learning model performing competency evaluation on a plurality of competencies and implemented by a computing device having at least one processor and at least one memory in which the machine learning model includes: a backbone artificial neural network module for deriving intermediate feature information from input data; and a sub-artificial neural network module for evaluating each competency from the intermediate feature information, and the device includes: a labeling learning unit for training the backbone artificial neural network module and the sub-artificial neural network module for the specific competency so as to reduce an error between a first prediction information obtained by inputting intermediate feature information, which is output by inputting learning input data for a specific competency to the backbone artificial neural network module, to the sub-artificial neural network module for the specific competency and labeling information for the learning input data.

In order to solve the above problem, a computer-readable medium for implementing the method for training a machine learning model performing competency evaluation on a plurality of competencies and performed on a computing device having at least one processor and at least one memory in which the machine learning model includes: a backbone artificial neural network module for deriving intermediate feature information from input data; and a sub-artificial neural network module for evaluating each competency from the intermediate feature information, and the method for training a machine learning model performing competency evaluation on a plurality of competencies includes a labeling learning step of training the backbone artificial neural network module and the sub-artificial neural network module for the specific competency so as to reduce an error between a first prediction information obtained by inputting intermediate feature information, which is output by inputting learning input data for a specific competency to the backbone artificial neural network module, to the sub-artificial neural network module for the specific competency and labeling information for the learning input data.

### Advantageous Effects

According to one embodiment of the present invention, evaluation results for each of a plurality of competencies to be evaluated from input data related to an answer or the like of an evaluatee can be automatically provided.

According to one embodiment of the present invention, an evaluation basis can be automatically provided to evaluation results for each of a plurality of competencies to be evaluated from input data related to an answer or the like of an evaluatee.

According to one embodiment of the present invention, the accuracy of inference results and the reduce of loads for inference computation can be implemented through a machine learning model in the form of sharing a backbone artificial neural network other than a machine learning model for each competency.

According to one embodiment of the present invention, the amount of computation for deriving inference results for different competencies can be reduced.

According to one embodiment of the present invention, a machine learning model related to inference of the other competency can be trained by using learning data of a specific competency.

According to one embodiment of the present invention, the backbone neural network module is shared, so that reduce time can be shortened and a memory usage can be reduced when an inference service model is established.

According to one embodiment of the present invention, learning beyond given learning data can be performed.

### DESCRIPTION OF DRAWINGS

FIG. 1 schematically shows the relevant internal configuration of a computing system for performing a method for training a machine learning model performing competency evaluation on a plurality of competencies according to one embodiment of the present invention.

FIG. 2 schematically shows operations of a preprocessor according to one embodiment of the present invention.

FIG. 3 exemplarily shows behavior indexes and questions for a specific competency according to one embodiment of the present invention.

FIG. 4 schematically shows an operation process of a machine learning model according to one embodiment of the present invention.

FIG. 5 schematically shows an example of labeling data according to one embodiment of the present invention.

FIG. 6 schematically shows a labeling learning step and a prediction labeling learning step according to one embodiment of the present invention.

FIG. 7 schematically shows a labeling learning step and a prediction labeling learning step according to one embodiment of the present invention.

FIG. 8 schematically shows a structure of the labeling learning step according to one embodiment of the present invention.

FIG. 9 schematically shows a learning process based on prediction labeling information according to one embodiment of the present invention.

FIG. 10 schematically shows a structure of the prediction labeling learning step according to one embodiment of the present invention.

FIG. 11 shows an example of a computing device that may correspond to a computing system or detailed components of the computing system according to one embodiment of the present invention.

### BEST MODE

### Mode for Invention

Hereinafter, embodiments of the present invention will be described in detail with reference to the accompanying drawings, so that a person having ordinary skill in the art may easily carry out the present invention. However, the invention may be embodied in various different forms and is not limited to the embodiments described herein. In addition, parts irrelevant to the description are omitted in the drawings to clearly describe the present invention, and like reference numerals designate like parts throughout the specification.

Throughout the specification, when a part is “connected” to another part, the above expression includes not only “directly connected” but also “electrically connected” in which another element is interposed therebetween. In addition, when a part “includes” a certain component, the above expression does not exclude other elements, but may further include the other elements, unless particularly stated otherwise.

In addition, the terms including an ordinal number such as first and second may be used to describe various elements, however, the components are not limited by the terms. The terms are used only for the purpose of distinguishing one component from another component. For example, the first component may be referred to as the second component without departing from the scope of the present invention, and similarly, the second component may also be referred to as the first component. The term “and/or” includes any one of a plurality of related listed items or a combination thereof.

In the specification, the term ‘unit’ includes a unit implemented by hardware, a unit implemented by software, and a unit implemented by both of the hardware and the software. In addition, one unit may be implemented using at least two pieces of hardware, and at least two units may be implemented by one piece of hardware. In addition, “˜ unit” may not be limited to software or hardware, may be configured to be disposed in an addressable storage medium, and may be configured to reproduce at least one processor. Accordingly, as an example, the ‘˜ unit’ includes components such as software components, object-oriented software components, class components, and task components, processes, functions, attributes, procedures, subroutines, segments of program code, drivers, firmware, microcode, circuits, data, databases, data structures, tables, arrays and variables. The functionality provided within the components and the ‘˜unit's may be combined into a smaller number of components and ‘˜ unit's or further separated into additional components and the ‘˜ unit's. In addition, the components and ‘˜ unit's may be implemented to reproduce at least one CPU in a device or a secure multimedia card.

In the specification herein, the “machine learning model” refers to a model that includes at least one machine learning model, and when at least one machine learning factor, for example, a deep artificial neural network factor is included, this is included in the category of “machine learning model” even though some steps operate according to a preset algorithm.

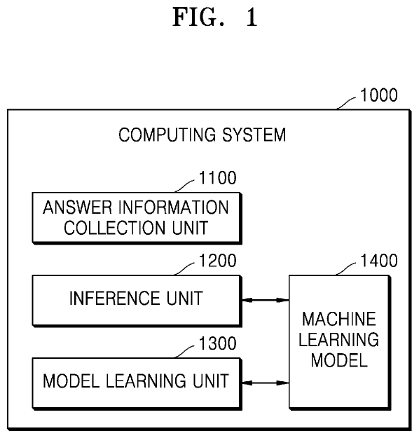

FIG. 1 schematically shows the relevant internal configuration of a computing system 1000 for performing a method for training a machine learning model 1400 performing competency evaluation on a plurality of competencies according to one embodiment of the present invention.

The method for training the machine learning model 1400 performing competency evaluation on a plurality of competencies and performed on a computing device having at least one processor and at least one memory may be performed by the computing system 1000 shown in FIG. 1.

The computing system 1000 may be implemented by a single computing device (for example, a server device), and may be implemented by a plurality of computing devices or an external device such as a storage device. For example, the machine learning model 1400 may be stored in a separate computing device or storage device, and may correspond to a form in which an inference unit 1200 and a model learning unit 1300 are physically implemented as different computing devices, respectively, and connected to each other through a network.

An answer information collection unit 1100 performs a function of collecting answer data from the outside. For example, the answer data may be unlabeled answer data serving as an object to be inferred in the inference unit 1200, or may be labeled answer data serving as an object to be learned in the model learning unit 1300.

Alternatively the answer information collection unit 1100 may be a form of providing a specific service and receiving a result therefrom. For example, it may correspond to a form of obtaining a video of the evaluatee based on services such as online interview evaluation or receiving evaluation information on a video of the evaluatee from the evaluator.

Alternatively the answer information collection unit 1100 may include a form of providing questions related to competency evaluation to a user terminal, and collecting answer information such as video, answer voice, answer text, and answer options subject to categories therefrom, or may include a form of providing target data for competency evaluation (for example, video, answer voice, answer text, and answer options subject to categories) to an evaluator terminal and collecting the evaluation information of the evaluator therefrom.

The answer information collection unit 1100 as described above is not limited to any form as long as it is a form of collecting data necessary for inference or learning of the inference unit 1200 and the model learning unit 1300.

In addition, the inference unit 1200 performs inference by using the machine learning model 1400. In the present invention, it corresponds to a form of providing evaluation information on a plurality of competencies for given answer data.

In addition, the model learning unit 1300 trains the machine learning model 1400 by using the answer data. A detailed process thereof will be described later.

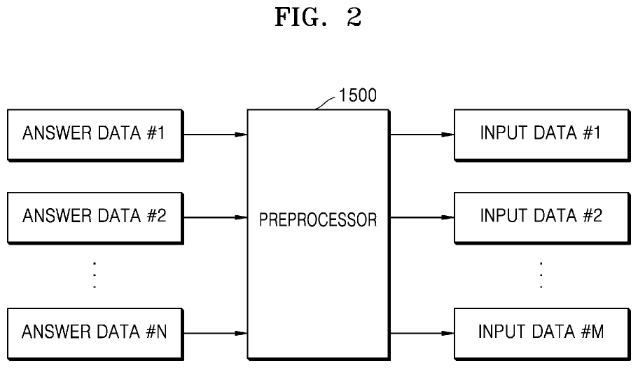

FIG. 2 schematically shows operations of a preprocessor 1500 according to one embodiment of the present invention.

In some embodiments of the present invention, the preprocessor 1500 shown in FIG. 2 is configured to be included in the inference unit 1200 and/or the model learning unit 1300 of FIG. 1. In another configuration of the present invention, the computing system 1000 may include a separate module for the preprocessor 1500.

The answer data may be input in a multiple form as shown in FIG. 2, but may correspond to a single form such as video data (voice and video) of the evaluatee.

The answer data may include at least one information related to the evaluatee, for example, such as video, answer voice, answer text, and answer options subject to categories, and may further include attribute information related to the corresponding evaluatee, information on a question itself or an attribute related to the answer of the evaluatee.

For example, when the user records and inputs a video for a specific question, answer data #1 may correspond to attribute information of the question and answer data #2 may correspond to video data. When the user inputs a script-type answer for a specific question, answer data #1 may correspond to attribute information of the question and answer data #2 may correspond to script-type text.

The above form of the response data may be implemented in single or in combination of video, text, voice raw data, answer options, question information related to the answer, question attribute information related to the answer, question implementation data related to the answer, and the like.

The preprocessor 1500 corresponds to a module for implementing all types of algorithms configured to convert at least one input answer data into a form that may be input to the machine learning model 1400. The preprocessor 1500 may also adopt at least one artificial neural network elements as needed.

In some embodiments of the invention, the preprocessor 1500 performs at least one of a role of separating the given answer data, a role of converting the given answer data, and a role of converting separated answer data elements.

For example, in some embodiments of the invention, when the answer data is a video file, video information (video) and voice information (voice raw data) are separated from the video file and then video feature information (for example, a specific frame or an information element extracted from a frame) and voice feature information (for example, voice raw data itself in a specific section or voice features extracted from the voice raw data (for example, MFCC and the like)) is extracted from the video information and the voice information, respectively, and generated as input data 1600.

In some embodiments of the invention, the number of answer data and the number of input data 1600 may be different from each other.

In some embodiments of the invention, when the machine learning model 1400 is multi-modal, an output value of the preprocessor 1500 may include a plurality of formats of input data 1600.

In some embodiments of the invention, the preprocessor 1500 may preprocess each of the video information and voice information which are input. In the preprocessor 1500, for the video information and the voice information, noise is removed through a data cleaning step, the data is converted through a custom transformers step, and a range of the data is set through a feature scaling step, and the above steps may be automated through a transformation pipelines step.

In some embodiments of the invention, the answer data may be voice text information or voice raw data. In the case of the latter, the preprocessor 1500 additionally performs speech-to-text (STT) conversion for the raw voice data. The voice text information converted in the above manner may derive input data 1600 by a step of performing embedding in which text information is expressed as a vector. The above voice embedding module may express voice text information into a vector form by using various embedding schemes such as One hot encoding, CountVectorizer, Tf-idf Vectorizer and Word2Vec.

In some embodiments of the invention, the answer data may be provided in the form of an answer video file and divided into video information, voice information and text information (through STT conversion) in the preprocessor 1500, and the video information (for example, an image frame or image frame sequence), the voice information and the text information are individually preprocessed and input to the machine learning model 1400. The video information and the voice information may be converted into a form suitable for the algorithm of the machine learning model 1400 through the preprocessor 1500, so that the performance of the machine learning model 1400 may be improved. As an example of a detailed process thereof, for the video information and the voice information, noise is removed through a data cleaning step in the preprocessor 1500, the data is converted through a custom transformers step, and a range of the data is set through a feature scaling step, and the above steps may be automated through a transformation pipelines step. The steps performed by the preprocessor 1500 are not limited to the above steps, and various preprocessing steps for the machine learning model 1400 may be included.

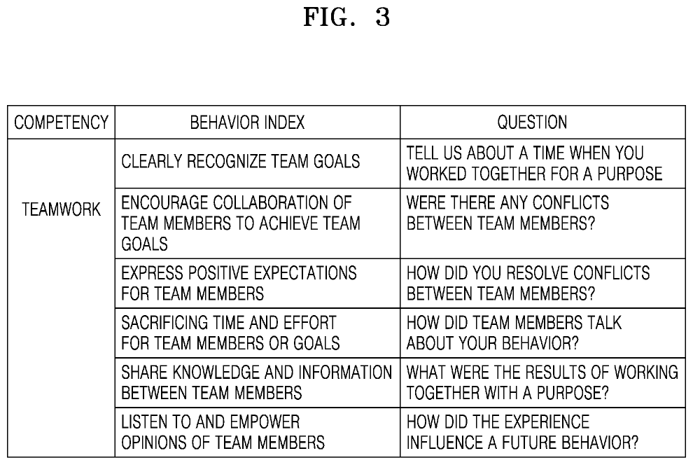

FIG. 3 exemplarily shows behavior indexes and questions for a specific competency according to one embodiment of the present invention.

The machine learning model 1400 derives evaluation results on each or at least one of a plurality of competencies based on the input data 1600.

The competency corresponds to an item to be evaluated, and the behavior index refers to at least one behavior related to the competency to be evaluated. At least one behavior index may be set for each competency, and at least one question may be set for each behavior index to discover the corresponding behavior index.

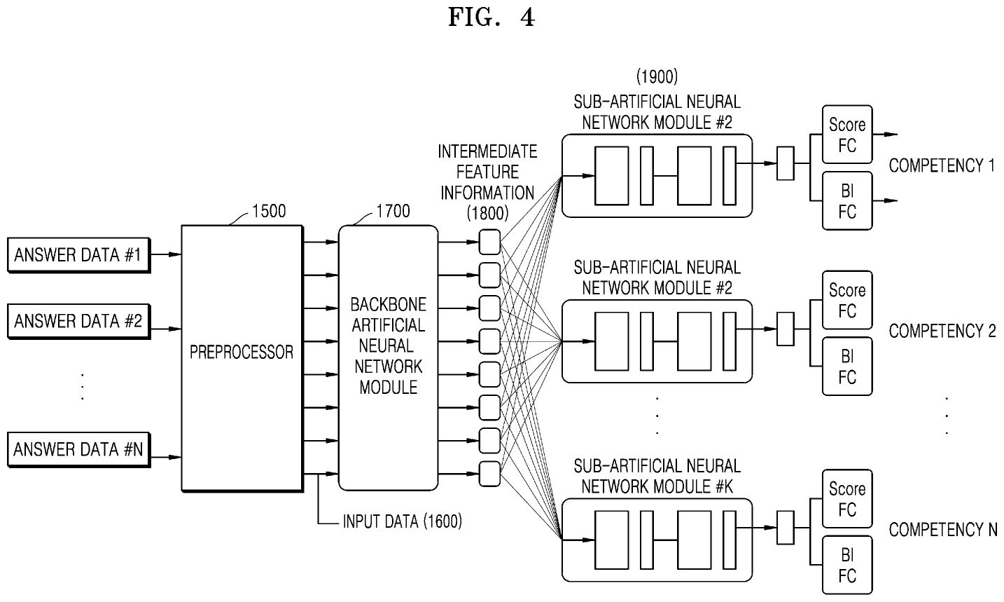

FIG. 4 schematically shows an operation process of the machine learning model 1400 according to one embodiment of the present invention.

The machine learning model 1400 includes: a backbone artificial neural network module 1700 for deriving intermediate feature information 1800 from input data 1600; and a sub-artificial neural network module 1900 for evaluating each competency from the intermediate feature information 1800.

The above-described preprocessor 1500 may be included in or separated from the machine learning model 1400. However, hereinafter, it will be assumed and described that the preprocessor 1500 is a form separated from the machine learning model 1400 for convenience of description.

As described above, at least one answer data is converted into at least one input data 1600 by the preprocessor 1500.

The input data 1600 is input to the backbone artificial neural network module 1700. The multi-task model uses a common backbone artificial neural network module 1700 in inferring various competencies. Compared to the case of implementing the machine learning model 1400 for each competency unlike the present invention, the present invention can train the backbone artificial neural network module 1700 in common by using learning data for other competencies, and reduce the computational load by using the backbone artificial neural network module 1700 for common parts even in inference.

The backbone artificial neural network module 1700 may be implemented as single modal or multi-modal. In the case of multi-modal, it may be preferable to input a plurality of pieces of input data 1600. However, the present invention is not limited thereto, and input data 1600 may be input in a different form.

The backbone artificial neural network module 1700 is connected to a plurality of sub-artificial neural network modules 1900 related to competencies, respectively. The sub-artificial neural network modules 1900 are trained to output evaluation results for the competency, respectively.

In some embodiments of the invention, the output information of the sub-artificial neural network module 1900 includes score information for the corresponding competency, and behavior index information for a behavior index in which the corresponding competency is found.

In some embodiments of the invention, the score information may be given as a probability value for each score category. For example, the score information may be output in the form of [x1, x2, x3, x4, x5], in which x1 may correspond to a probability of 0 points, x2 to a probability of 1 points, x3 to a probability of 2 points, x4 to a probability of 3 points, and x5 to a probability of 4 points. Alternatively, the score information may include regression values for a plurality of inferred scores. In this case, an average value, a standard deviation, and the like for the corresponding competency may be included.

According to one embodiment of the present invention, the input data 1600 may include text, and the output information of the sub-artificial neural network module 1900 may include the corresponding competency or a position in which the behavior index related to the corresponding competency is found in the text.

In this case, an output value of the sub-artificial neural network module 1900 may include an overall evaluation score for the corresponding competency as well as information on an accurate part in which the machine learning model 1400 of the present invention made a judgment related to the corresponding competency in the input data 1600 or the answer data, and/or information on an accurate part in which the machine learning model made a judgment related to the behavior index related to the corresponding competency in the input data 1600 or the answer data.

Likewise, according to one embodiment of the present invention, the input data 1600 may include video information or voice information with or without preprocessing, and the output information of the sub-artificial neural network module 1900 may include time information or position in video information or voice information in which the corresponding competency or behavior index related to the corresponding competency is found.

In this case, an output value of the sub-artificial neural network module 1900 may include an overall evaluation score for the corresponding competency as well as information on an accurate part in which the machine learning model 1400 of the present invention made a judgment related to the corresponding competency in the input data 1600 or the answer data, and/or information on an accurate part in which the machine learning model made a judgment related to the behavior index related to the corresponding competency in the input data 1600 or the answer data.

According to one embodiment of the present invention, the input data 1600 may include at least one of text, voice information, and video information with or without preprocessing, and the backbone artificial neural network module 1700 may correspond to a multi-modal artificial neural network module.

According to one embodiment of the present invention, the input data 1600 includes tokenized text information and category information of a question related to the text information, and the machine learning model 1400 for performing the competency evaluation includes a model for evaluating competency based on at least one of past behaviors and attitudes.

According to one embodiment of the present invention, the machine learning model 1400 may correspond to a model for evaluating the evaluatee based on past behavior. For example, in order to evaluate the competency of ‘teamwork’ as shown in FIG. 3, it may correspond to a model for evaluating a corresponding evaluatee based on detection of a plurality of behavior indexes and determination thereof.

The category information of the question may include, for example, 1) whether the question is a question about explaining the background for the situation, 2) whether the question is a question about what was the occurring task or event and what was I had to do, 3) whether the question is a question about what is my behavior in response to the event, and 4) whether the question is a question about what is my result, achievement or realization for the task and behavior.

As in the above, according to one embodiment of the present invention, the category information on the question (for example, tokenized information about which type of question among the above 1) to 4)), and tokenized information on the answer text may be input to the backbone artificial neural network.

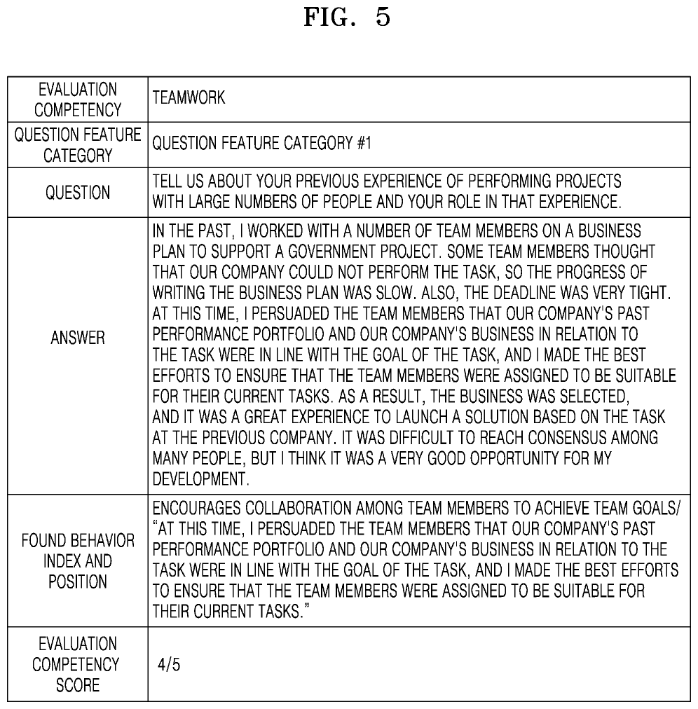

FIG. 5 schematically shows an example of labeling data according to one embodiment of the present invention.

The labeling data corresponds to data used to train the machine learning model 1400. As shown in FIG. 5, the labeling data according to one embodiment of the present invention may include information on evaluation competency, information on a question feature category (for example, which type among the above 1) to 4)), information on a question, information on an answer content (the answer content is given in a text form in FIG. 5), a discovered behavior index and a position related to the discovery, and evaluation scores for the evaluation competency.

In some embodiments of the invention, the labeling data may be implemented by excluding or adding some information in elements shown in FIG. 5.

For example, the answer content may be given as a video file, and information on the ‘discovered behavior index and related answer content’ may be omitted.

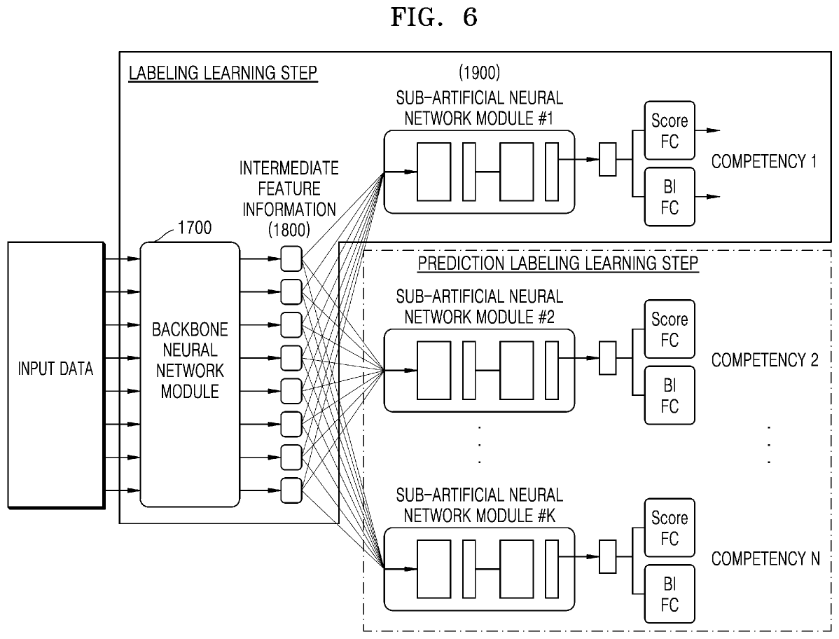

FIG. 6 schematically shows a labeling learning step and a prediction labeling learning step according to one embodiment of the present invention.

As described hereinafter, in some embodiments of the present invention, based on labeling data for a specific competency, the backbone artificial neural network and the sub-artificial neural network for the corresponding competency are trained. Thereafter, a sub-artificial neural network for a competency other than the specific competency may be trained based on the data for the specific competency. In this case, FIG. 6 shows a state in which the backbone artificial neural network and the sub-artificial neural network for the corresponding competency are trained and the sub-artificial neural network for the remaining competencies is not trained.

Details of the learning step will be described later.

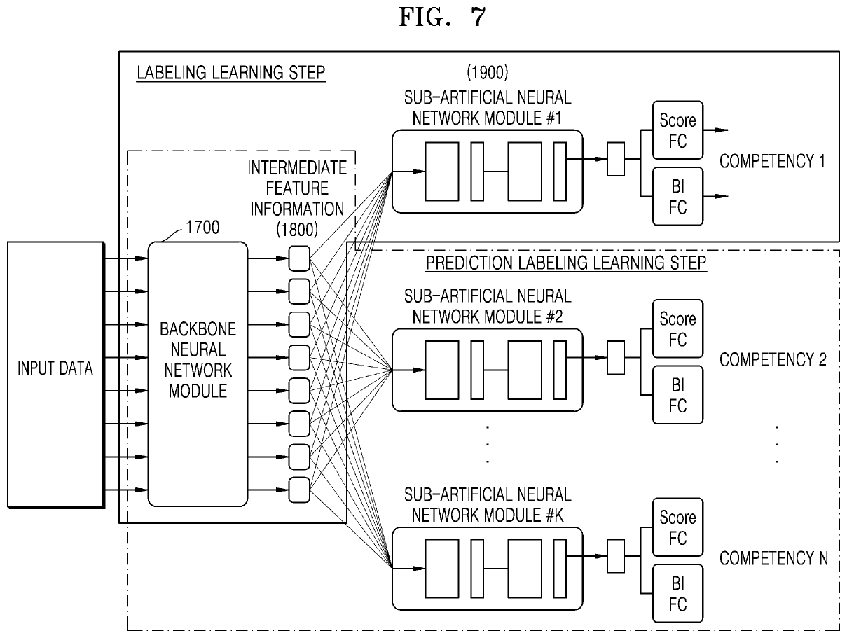

FIG. 7 schematically shows a labeling learning step and a prediction labeling learning step according to one embodiment of the present invention.

As described later, in some embodiments of the present invention, based on labeling data for a specific competency, the backbone artificial neural network and the sub-artificial neural network for the corresponding competency are trained. Thereafter, a sub-artificial neural network for a competency other than the specific competency may be trained again based on the data for the specific competency together with the backbone artificial neural network.

Details of the learning step will be described later.

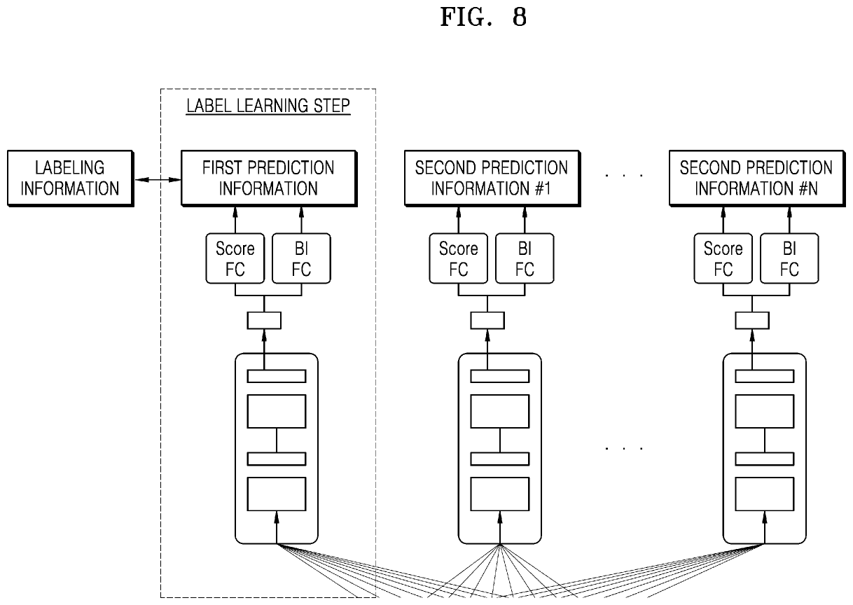

FIG. 8 schematically shows a structure of the labeling learning step according to one embodiment of the present invention.

In the labeling learning step according to some embodiments of the present invention, the backbone artificial neural network module 1700 and the sub-artificial neural network module 1900 for the specific competency are trained so as to reduce an error between a first prediction information obtained by inputting intermediate feature information 1800, which is output by inputting learning input data 1600 for the specific competency to the backbone artificial neural network module 1700, to the sub-artificial neural network module 1900 for the specific competency and labeling information for the learning input data 1600.

In order to describe the above process in detail, it is assumed that the learning input data 1600 contains category information on a question, that is, information on ‘1) whether the question is a question about explaining the background for the situation’, and tokenized information from the text “I did ˜˜ whenever I had a hard time”.

The learning input data 1600 is input to the backbone artificial neural network module 1700, the backbone artificial neural network module 1700 derives the intermediate feature information 1800, and the derived intermediate feature information 1800 is input to each of the sub-artificial neural network modules 1900. Thereafter, each of the sub-artificial neural network modules 1900 derives evaluation information on all competencies (for example, scores for the corresponding competency, and information on whether each behavior index related to each corresponding competency is discovered or on probability of discovery).

In the labeling learning step, when, for example, the learning input data 1600 is learning data for competency 1, a loss with first prediction information serving as an output value of the sub-artificial neural network module 1900 for competency 1 and labeling information on the learning input data 1600 is calculated, and the sub-artificial neural network module 1900 and the backbone artificial neural network module 1700 for competency 1 are trained in the direction of minimizing the loss.

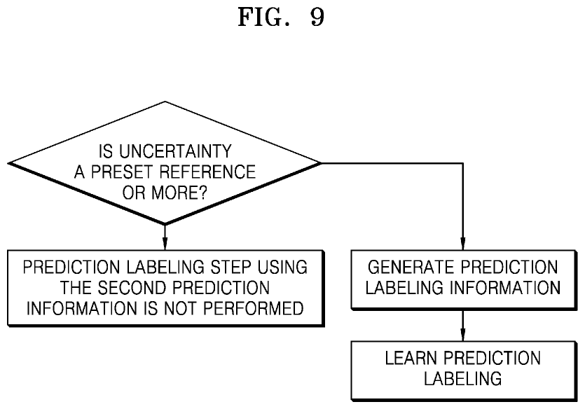

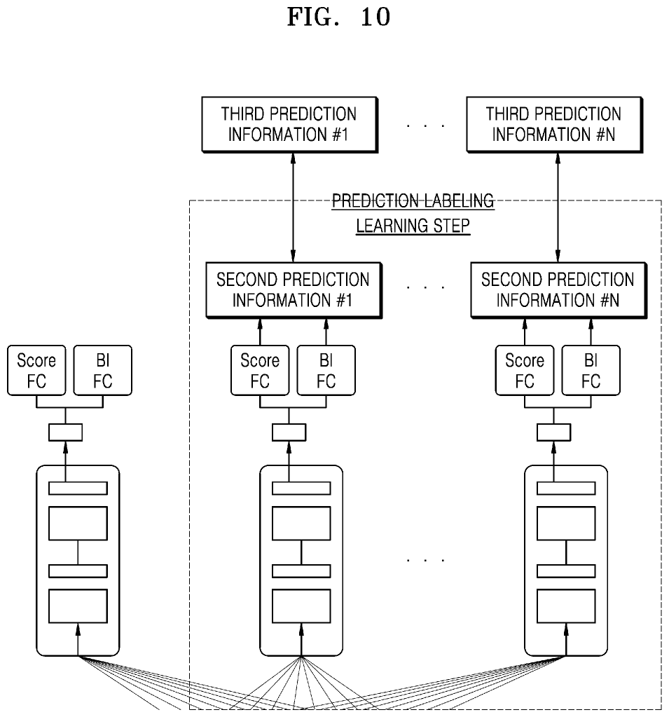

FIG. 9 schematically shows a learning process based on prediction labeling information according to one embodiment of the present invention. FIG. 10 schematically shows a structure of the prediction labeling learning step according to one embodiment of the present invention. Hereinafter, the prediction labeling learning step according to the embodiments of the present invention will be described with reference to FIGS. 9 and 10.

In general the accuracy of inference in the deep artificial neural network may be improved by labeled learning data. However, it may take considerable cost and time to ensure the labeled learning data. In particular, it may take more cost and time in the case of labeling data for a specific competency in the human video, answer voice, answer text, answer options subject to categories, and the like as in the present invention.

In order to solve the above problem, according to some embodiments of the present invention, the method for training a machine learning model 1400 performing competency evaluation on a plurality of competencies further includes: a prediction labeling learning step of calculating a loss based on second prediction information obtained by inputting intermediate feature information, which is output by inputting learning input data for the specific competency to the backbone artificial neural network module, to the sub-artificial neural network module for other competency different from the specific competency, and training a sub-artificial neural network module for other competency different from the specific competency or a sub-artificial neural network module and a backbone artificial neural network module for other competency different from the specific competency so as to reduce the loss.

In the above manner, the sub-artificial neural network module 1900 for different competency other than the specific competency is trained by using learning input data 1600 for a specific competency and labeling information thereon, so that a lot of learning can be performed with little training data.

Preferably, in the prediction labeling learning step as shown in FIG. 9, and when the uncertainty of the prediction result calculated from the second prediction information is a preset reference or more, the prediction labeling learning step related to the second prediction information is not performed.

According to one embodiment of the present invention, in the prediction labeling learning step, the loss is calculated by considering uncertainty of a prediction result calculated from the second prediction information.

According to one embodiment of the present invention, the second prediction information includes probability information for a plurality of result classes, and in the prediction labeling learning step, the loss is calculated by considering uncertainty in probability information of each of the result classes. In order for considering the uncertainty of the second prediction information including the probability value, various algorithms may be used.

For example, in the answer data, when category information of a related question includes 1) whether the question is a question about explaining the background for the situation, and the answer content is “Yes, colleagues helped”, and the labeling information includes competency 1, competency score 0, and no behavior index, a process of learning sub-artificial neural network modules 1900 related to competency 2, competency 3, . . . , and competency N will be described.

The response data may be preprocessed as a tokenized form of data [24, 5, 6, 11, 13, 4] through the preprocessor 1500 and converted into input learning data.

The above input learning data is input to the backbone artificial neural network module 1700 to derive intermediate feature information 1800, and the sub-artificial neural network module 1900 related to competency 1 is trained using the intermediate feature information 1800 and the labeling information as described above.

In addition, the intermediate feature information 1800 is input to the sub-artificial neural network module 1900 related to competencies 2, 3, . . . , and N, and the sub-artificial neural network module 1900 derives second prediction information 2, 3, . . . , and N as shown in FIG. 10.

Thereafter, third prediction information 2, 3, . . . , and N may be derived by considering the degree of uncertainty of second prediction information 2, 3, . . . , and N.

According to one embodiment of the present invention, data related to a score of the corresponding competency of the second prediction information output by the sub-artificial neural network module 1900 may be given in a form of [x1, x2, x3, . . . , xn] in which x1 may correspond to a probability value of a first score, x2 to a probability value of a second score, x3 to a probability value of a third score, and xn to a probability value of an nth score.

For example, when there are 5 points, data related to a score of a corresponding competency of second prediction information output from a sub-artificial neural network module 1900 for competency i other than competency 1 is [0.8, 0.0, 0.1, 0.05, 0.05], and x1 is 0 points, x2 is 1 points, x3 is 2 points, x4 is 3 points, and x5 is 4 points, third prediction information may be derived in consideration of uncertainty.

According to one embodiment of the present invention, the third prediction information may be extracted based on whether the probability value satisfies a predetermined reference. For example, when a probability value of higher than 0.7 is applied as the reference, the labeling information related to the score of the corresponding competency of the third prediction information may take a probability value of 0.8 corresponding to x1, thereby being determined as 0 points. The third prediction information may correspond to prediction labeling information.

Various methods may be applied to the method of deriving the third prediction information from the second prediction information by considering the uncertainty. In another embodiment of the present invention, even when an argmax function is used, the labeling information related to the score of the corresponding competency of the third prediction information may take a probability value of 0.8 corresponding to x1, thereby being determined as 0 points.

For example, when there are 5 points, data related to a score of a corresponding competency of second prediction information output from a sub-artificial neural network module 1900 for competency i other than competency 1 is [0.8, 0.0, 0.1, 0.05, 0.05], and the argmax is used, the third prediction information may be given as [1, 0, 0, 0, 0], and the corresponding sub-artificial neural network module 1900 is trained to reduce an error between the third prediction information and the second prediction information.

In addition, in another embodiment of the present invention, the second prediction information may include a regression result value and deviation information, and in the prediction labeling learning step, the uncertainty derived from the deviation information is taken into consideration.

According to one embodiment of the present invention, in the prediction labeling learning step, the loss is calculated by considering uncertainty of a prediction result calculated from the second prediction information.

According to one embodiment of the present invention, when the second prediction information is output as a specific regression result value, the corresponding regression result value may be generated as third prediction information or prediction labeling learning of a related sub-artificial neural network module may be performed only when deviation information therefor, for example, the standard deviation is within a preset range. When the standard deviation is deviated from the preset range, the third prediction information may not be generated or the prediction labeling learning may not be performed.

In the above case, according to one embodiment of the present invention, in the prediction labeling learning step, the third prediction information is used as prediction labeling information with respect to the sub-artificial neural network module 1900 for a different competency other than the competency related to the learning input data 1600, and the sub-artificial neural network module 1900 for the other competency is trained so as to reduce the error between the second prediction information and the third prediction information.

The above process may be expressed by the equation as follows.

$$L = {\sum }_{c = 1}^{C} {\sum }_{i = 1}^{N} 1 \{ {x}_{i}^{c} , {y}_{i}^{c} ⊂ {X}_{c}^{′} \} CE ( {y}_{i}^{c} , {h}^{s} ( {f}^{c} ( g ( {x}_{i} ) ) ) ) + α * BCE ( {q}_{i}^{c} , {h}^{b} ( {f}^{c} ( g ( {x}_{i} ) ) ) ) \qquad ( 1 )$$

$${X}_{c}^{′} = \{ ( {x}_{n}^{c} , {y}_{n}^{c} , {q}_{n}^{c} ) : n ∈ ( 1 , … , \vert {X}_{c}^{′} \vert ) \} \qquad ( 2 )$$

$$X = \{ {X}_{1}^{′} , {X}_{2}^{′} , … , {X}_{c}^{′} \} \qquad ( 3 )$$

Wherein, N is the number of learning input data 1600 indexed by i, C is the number of competencies indexed by c, X′c is a corresponding competency subset, CE is a cross-entropy loss function, BCE is a binary cross-entropy loss function, and a is a hyperparameter for adjusting a size of BCE.

As in the above equation, since the labeling information for the specific competency of the learning input data 1600 according to one embodiment of the present invention is Ground Truth, the loss of the sub-artificial neural network module 1900 for the corresponding competency is calculated, and the corresponding sub-artificial neural network module 1900 is trained in the direction of reducing the loss.

In addition, according to one embodiment of the present invention, an inference value (second prediction information) may also come out through the sub-artificial neural network module 1900 for a competency different from the specific competency connected to the backbone artificial neural network module 1700. However, the learning may conducted without applying the inference value as it is, and it may be applied only to the corresponding competency C as in Equation (1).

In addition, in the above equation, the CE term is a part for inferring a competency score and the BCE term is a part for inferring a behavior index discovery probability, and these may vary depending on definition of an output form of the sub-artificial neural network module 1900.

In addition, according to one embodiment of the present invention, the BCE term is multiplied by a (hyperparameter), and accordingly, a weight may be different for an inference loss on competency score and an inference loss on behavior index. For example, when it is more important to match with the competency score, a may be lowered to reduce the effect of the inference loss on behavior index, so that the accuracy of behavior index discovery probability may decrease but the accuracy of competency score may increase.

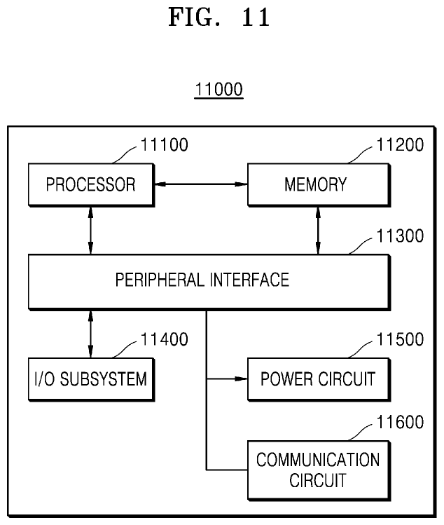

FIG. 11 schematically shows internal components of the computing device according to one embodiment of the present invention.

The computing system 1000 shown in the above-described FIG. 1 may include components of the computing device 11000 shown in FIG. 11.

As shown in FIG. 11, the computing device 11000 may at least include at least one processor 11100, a memory 11200, a peripheral device interface 11300, an input/output subsystem (I/O subsystem) 11400, a power circuit 11500, and a communication circuit 11600. The computing device 11000 may correspond to the computing device 1000 shown in FIG. 1.

The memory 11200 may include, for example, a high-speed random access memory, a magnetic disk, an SRAM, a DRAM, a ROM, a flash memory, or a non-volatile memory. The memory 11200 may include a software module, an instruction set, or other various data necessary for the operation of the computing device 11000.

The access to the memory 11200 from other components of the processor 11100 or the peripheral interface 11300, may be controlled by the processor 11100.

The peripheral interface 11300 may combine an input and/or output peripheral device of the computing device 11000 to the processor 11100 and the memory 11200. The processor 11100 may execute the software module or the instruction set stored in memory 11200, thereby performing various functions for the computing device 11000 and processing data.

The input/output subsystem may combine various input/output peripheral devices to the peripheral interface 11300. For example, the input/output subsystem may include a controller for combining the peripheral device such as monitor, keyboard, mouse, printer, or a touch screen or sensor, if needed, to the peripheral interface 11300. According to another aspect, the input/output peripheral devices may be combined to the peripheral interface 11300 without passing through the I/O subsystem.

The power circuit 11500 may provide power to all or a portion of the components of the terminal. For example, the power circuit 11500 may include a power failure detection circuit, a power converter or inverter, a power status indicator, a power failure detection circuit, a power converter or inverter, a power status indicator, or any other components for generating, managing, and distributing the power.

The communication circuit 11600 may use at least one external port, thereby enabling communication with other computing devices.

Alternatively, as described above, if necessary, the communication circuit 11600 may transmit and receive an RF signal, also known as an electromagnetic signal, including RF circuitry, thereby enabling communication with other computing devices.

The above embodiment of FIG. 11 is merely an example of the computing device 11000, and the computing device 11000 may have a configuration or arrangement in which some components shown in FIG. 11 are omitted, additional components not shown in FIG. 11 are further provided, or at least two components are combined. For example, a computing device for a communication terminal in a mobile environment may further include a touch screen, a sensor or the like in addition to the components shown in FIG. 11, and the communication circuit 11600 may include a circuit for RF communication of various communication schemes (such as WiFi, 3G, LTE, Bluetooth, NFC, and Zigbee). The components that may be included in the computing device 11000 may be implemented by hardware, software, or a combination of both hardware and software which include at least one integrated circuit specialized in a signal processing or an application.

The methods according to the embodiments of the present invention may be implemented in the form of program instructions to be executed through various computing devices, thereby being recorded in a computer-readable medium. In particular, a program according to an embodiment of the present invention may be configured as a PC-based program or an application dedicated to a mobile terminal. The application to which the present invention is applied may be installed in the computing device 11000 through a file provided by a file distribution system. For example, a file distribution system may include a file transmission unit (not shown) that transmits the file according to the request of the computing device 11000.

The above-mentioned device may be implemented by hardware components, software components, and/or a combination of hardware components and software components. For example, the devices and components described in the embodiments may be implemented by using at least one general purpose computer or special purpose computer, such as a processor, a controller, an arithmetic logic unit (ALU), a digital signal processor, a microcomputer, a field programmable gate array (FPGA), a programmable logic unit (PLU), a microprocessor, or any other device capable of executing and responding to instructions. The processing device may execute an operating system (OS) and at least one software application executed on the operating system. In addition, the processing device may access, store, manipulate, process, and create data in response to the execution of the software. For the further understanding, some cases may have described that one processing device is used, however, it is well known by those skilled in the art that the processing device may include a plurality of processing elements and/or a plurality of types of processing elements. For example, the processing device may include a plurality of processors or one processor and one controller. In addition, other processing configurations, such as a parallel processor, are also possible.

Although the above-described present invention has been described with a focus on a machine learning model that performs a function of determining a specific competency for an individual to be evaluated and using behavioral indicators related to past behaviors as a basis for determining the corresponding competency, the present invention is not limited thereto, Determination is performed on each of a plurality of characteristics of one or more of audio, video, and text related to a specific object such as an organism or non-living object and/or data processed for audio, video, and text, It can be applied even when there is one or more characteristic indicators as the basis for the judgment. For example, the input data corresponds to a medical image, and in predicting each of a plurality of diseases from the medical image, there is one or more characteristic indicators for each of the plurality of diseases, and each of the plurality of diseases according to the detection of such characteristic indicators A multi-task inference model that performs judgment on may also be included in the modified example of the present invention.

The software may include a computer program, a code, and an instruction, or a combination of at least one thereof, and may configure the processing device to operate as desired, or may instruct the processing device independently or collectively. In order to be interpreted by the processor or to provide instructions or data to the processor, the software and/or data may be permanently or temporarily embodied in any type of machine, component, physical device, virtual equipment, computer storage medium or device, or in a signal wave to be transmitted. The software may be distributed over computing devices connected to networks, so as to be stored or executed in a distributed manner. The software and data may be stored in at least one computer-readable recording medium.

The method according to the embodiment may be implemented in the form of program instructions to be executed through various computing mechanisms, thereby being recorded in a computer-readable medium. The computer-readable medium may include program instructions, data files, data structures, and the like, independently or in combination thereof. The program instructions recorded on the medium may be specially designed and configured for the embodiment, or may be known to those skilled in the art of computer software so as to be used. An example of the computer-readable medium includes a magnetic medium such as a hard disk, a floppy disk and a magnetic tape, an optical medium such as a CD-ROM and a DVD, a magneto-optical medium such as a floptical disk, and a hardware device specially configured to store and execute a program instruction such as ROM, RAM, and flash memory. An example of the program instruction includes a high-level language code to be executed by a computer using an interpreter or the like as well as a machine code generated by a compiler. The above hardware device may be configured to operate as at least one software module to perform the operations of the embodiments, and vise versa.

According to one embodiment of the present invention, evaluation results for each of a plurality of competencies to be evaluated from input data related to an answer or the like of an evaluatee can be automatically provided.

According to one embodiment of the present invention, an evaluation basis can be automatically provided to evaluation results for each of a plurality of competencies to be evaluated from input data related to an answer or the like of an evaluatee.

According to one embodiment of the present invention, the accuracy of inference results and the reduce of loads for inference computation can be implemented through a machine learning model in the form of sharing a backbone artificial neural network other than a machine learning model for each competency.

According to one embodiment of the present invention, the amount of computation for deriving inference results for different competencies can be reduced.

According to one embodiment of the present invention, a machine learning model related to inference of the other competency can be trained by using learning data of a specific competency.

According to one embodiment of the present invention, the backbone neural network module is shared, so that reduce time can be shortened and a memory usage can be reduced when an inference service model is established.

According to one embodiment of the present invention, learning beyond given learning data can be performed.

An embodiment of the present invention may be implemented in the form of a recording medium including instructions executable by a computer, such as program modules executed by a computer. Computer readable media can be any available media that can be accessed by a computer and includes both volatile and nonvolatile media, removable and non-removable media. Also, computer readable media may include both computer storage media and communication media. Computer storage media includes both volatile and nonvolatile, removable and non-removable media implemented in any method or technology for storage of information such as computer readable instructions, data structures, program modules or other data. Communication media typically includes computer readable instructions, data structures, program modules, or other data in a modulated data signal such as a carrier wave, or other transport mechanism, and includes any information delivery media.

Although the methods and systems of the present invention have been described with reference to specific embodiments, some or all of their components or operations may be implemented using a computer system having a general-purpose hardware architecture.

Although the above embodiments have been described with reference to the limited embodiments and drawings, however, it will be understood by those skilled in the art that various changes and modifications may be made from the above-mentioned description. For example, even though the described descriptions may be performed in an order different from the described manner, and/or the described components such as system, structure, device, and circuit may be coupled or combined in a form different from the described manner, or replaced or substituted by other components or equivalents, appropriate results may be achieved.

Therefore, other implementations, other embodiments, and equivalents to the claims are also within the scope of the following claims.

1. A method for training a machine learning model performing competency evaluation on a plurality of competencies and performed on a computing device having at least one processor and at least one memory in which
the machine learning model includes:
a backbone artificial neural network module for deriving intermediate feature information from input data; and
a sub-artificial neural network module for evaluating each competency from the intermediate feature information, the method comprising:
a labeling learning step of training the backbone artificial neural network module and the sub-artificial neural network module for a specific competency so as to reduce an error between a first prediction information obtained by inputting intermediate feature information, which is output by inputting learning input data for the specific competency to the backbone artificial neural network module, to the sub-artificial neural network module for the specific competency and labeling information for the learning input data.

2. The method of claim 1, wherein output information of the sub-artificial neural network module includes score information for a corresponding competency and behavior index information for a behavior index in which the corresponding competency is found.

3. The method of claim 1, wherein the input data includes text, and output information of the sub-artificial neural network module includes a corresponding competency or a position in which a behavior index related to the corresponding competency is found in the text.

4. The method of claim 1, wherein the input data includes video information or voice information with or without preprocessing, and
output information of the sub-artificial neural network module includes time information or position in video information or voice information in which a corresponding competency or behavior index related to the corresponding competency is found.

5. The method of claim 1, further comprising:
a prediction labeling learning step of calculating a loss based on second prediction information obtained by inputting intermediate feature information, which is output by inputting learning input data for the specific competency to the backbone artificial neural network module, to the sub-artificial neural network module for other competency different from the specific competency, and training a sub-artificial neural network module for other competency different from the specific competency or a sub-artificial neural network module and a backbone artificial neural network module for other competency different from the specific competency so as to reduce the loss.

6. The method claim 5, wherein the prediction labeling learning step includes
calculating the loss by considering uncertainty of a prediction result calculated from the second prediction information.

7. The method claim 5, wherein the second prediction information includes probability information for a plurality of result classes, and
the prediction labeling learning step includes calculating the loss by considering uncertainty in probability information of each of the result classes.

8. The method of claim 5, wherein the second prediction information includes a regression result value and deviation information, and
the prediction labeling learning step includes calculating the loss by considering uncertainty derived from the deviation information.

9. The method of claim 5, wherein the prediction labeling learning step includes
training a sub-artificial neural network module for other competency different from the specific competency or a sub-artificial neural network module and a backbone artificial neural network module for other competency different from the specific competency, so as to reduce an error between a second prediction information obtained by inputting intermediate feature information, which is output by inputting learning input data for the specific competency to the backbone artificial neural network module, to a sub-artificial neural network module for other competency different from the specific competency and prediction labeling information generated in consideration of uncertainty of the second prediction information.

10. The method of claim 5, wherein the prediction labeling learning step includes
excluding the prediction labeling learning step related to the second prediction information when uncertainty of a prediction result calculated from the second prediction information is a preset reference or more.

11. The method of claim 1, wherein the input data includes at least one of text, voice information, and video information with or without preprocessing, and
the backbone artificial neural network module includes a single modal or multi-modal artificial neural network module.

12. The method of claim 1, wherein the input data includes tokenized text information and category information of a question related to the text information, and
the machine learning model for performing the competency evaluation includes a model for evaluating competency based on at least one of past behaviors and attitudes.

13. A device for training a machine learning model performing competency evaluation on a plurality of competencies and implemented by a computing device having at least one processor and at least one memory in which
the machine learning model includes:
a backbone artificial neural network module for deriving intermediate feature information from input data; and
a sub-artificial neural network module for evaluating each competency from the intermediate feature information, the device comprising:
a labeling learning unit for training the backbone artificial neural network module and a sub-artificial neural network module for a specific competency, so as to reduce an error between a first prediction information obtained by inputting intermediate feature information, which is output by inputting learning input data for the specific competency to the backbone artificial neural network module, to the sub-artificial neural network module for the specific competency and labeling information for the learning input data.

14. A computer-readable medium for implementing the method for training a machine learning model performing competency evaluation on a plurality of competencies and performed on a computing device having at least one processor and at least one memory, wherein
the machine learning model includes:
a backbone artificial neural network module for deriving intermediate feature information from input data; and
a sub-artificial neural network module for evaluating each competency from the intermediate feature information, and
the method includes:
a labeling learning step of training the backbone artificial neural network module and a sub-artificial neural network module for a specific competency, so as to reduce an error between a first prediction information obtained by inputting intermediate feature information, which is output by inputting learning input data for the specific competency to the backbone artificial neural network module, to the sub-artificial neural network module for the specific competency and labeling information for the learning input data.
